(19) United States
(12) Patent Application Publication
(10) Pub. No.: US 2013/0048599 A1
(43) Pub. Date: Feb. 28, 2013

(54) PLASMA ETCHING METHOD

(71) Applicants: Makoto SATAKE, Tokyo (JP); Makoto Suyama, Yanai-shi (JP); Masato Ishimaru, Hikari-shi (JP); Yasukiyo Morioka, Kudamatsu-shi (JP)

(72) Inventors: Makoto SATAKE, Tokyo (JP); Makoto Suyama, Yanai-shi (JP); Masato Ishimaru, Hikari-shi (JP); Yasukiyo Morioka, Kudamatsu-shi (JP)

(21) Appl. No.: 13/363,506

(22) Filed: Feb. 1, 2012

(30) Foreign Application Priority Data
Aug. 30, 2011 (JP) 2011-186809

(51) Int. Cl. H01F 41/00; B44C 1/22

(52) U.S. Cl. 216/22; 216/67

(57) ABSTRACT

The present invention provides a method for stably generating cleaning plasma regardless of a condition of CO-containing plasma. When a magnetic film formed on a wafer 802 to be etched is processed with the CO-containing plasma which is generated by applying a source electric power to a CO-containing gas containing elements of C and O, which has been introduced into a vacuum chamber 801, to convert the CO-containing gas into a plasma state, the method includes: applying predetermined processing to the magnetic film formed on the wafer 802 to be etched by using the CO-containing plasma; then introducing a cleaning gas into the vacuum chamber in a state of applying the source electric power 806 to the antenna; and then stopping the introduction of the CO-containing gas into the vacuum chamber to thereby generate the cleaning plasma with the use of a predetermined cleaning gas.

The present application is based on and claims priority of Japanese patent application No. 2011-186809 filed on Aug. 30, 2011, the entire contents of which are hereby incorporated by reference.

### BACKGROUND OF THE INVENTION

1. Field of the Invention

The present invention relates to a plasma etching method of an object to be processed such as a magnetic film which is used for a magnetic resistance memory and the like.

2. Description of the Related Art

Along with recent increase in the amount of information, it is desired that electronic equipment has low electric power consumption and that a memory operates at high speed and is nonvolatile. A currently used memory includes DRAM (Dynamic Random Access Memory) and a flash memory, which use the accumulation of electric charge. The DRAM is used as a main memory of a computer, but is a volatile memory which loses memory when a power source is turned off. In addition, the DRAM needs to be rewritten at every fixed time in order to hold a data during its operation, which increases the electric power consumption. On the other hand, the flash memory is a nonvolatile memory, but the writing time is as long as an order of μ seconds. An MRAM (Magnetic Random Access Memory) is expected to adapt as a nonvolatile memory which has not those defects, has low electric power consumption and operates at high speed.

The MRAM is a memory utilizing a change of a resistance value according to a direction of magnetization, and when the MRAM is manufactured, a technology is needed which finely processes a magnetic film containing an element such as Fe, Co and Ni formed on a substrate, with a dry etching technique while using a mask formed by lithography.

There are an ion beam etching technique and a plasma etching technique in the dry etching techniques, but the plasma etching technique, in particular, is widely used for manufacturing a semiconductor device and is excellent in productivity because of being capable of uniformly processing a large diameter substrate.

The plasma etching process is proceeded by introducing a gas for processing into a decompressed processing chamber, charging a radio-frequency electric power (hereinafter described as a source electric power) into the processing chamber from the power source through a flat plate antenna, a coiled antenna or the like to thereby convert the gas into a plasma state, and irradiating the substrate with thereby generated ions and radicals. There are various methods in plasma sources according to the difference of a method of generating plasma, which include an effective magnetic field microwave type, an inductively coupled (ICP: Inductively Coupled Plasma) type and a capacitively coupled (CCP: Capacitively Coupled Plasma) type.

The method of processing the magnetic film with the plasma etching technique includes a method of utilizing the production of a chloride of the magnetic film with Cl₂ plasma generated by converting Cl₂ gas into a plasma state, and a method of utilizing the production of a metal carbonyl of a magnetic film with CO-containing plasma generated by converting a gas containing CO like a mixed gas of CO and NH₃ or a CH₃OH gas into the plasma state. The latter method of using the CO-containing plasma, in particular, is expected as the method of processing the magnetic film unlike the method with Cl₂ plasma, because there is no need to worry about corrosion, and the metal carbonyl has a higher saturation vapor pressure than that of the chloride and is anticipated to easily progress etching.

However, according to the etching method of using the CO-containing gas, a C-based deposit which has been dissociated during etching deposits on the inner wall of a vacuum chamber, and the state in the vacuum chamber varies before and after the etching. Because of this, it is necessary to return the state in the vacuum chamber to its original state by removing the C which has deposited on the inner wall of the vacuum chamber with cleaning plasma that has been generated by using O₂ gas or the like, after having etched the magnetic film.

For instance, Japanese Patent Laid-Open Publication No. 10-12593 (Patent Document 1) discloses a technology of conducting the cleaning process in a state in which a cleaning wafer is placed on a wafer stage, when removing an unnecessary deposit on the inner wall face of the vacuum chamber in an apparatus for manufacturing a semiconductor device with the plasma.

A conventional method of returning the state of the inner wall of the vacuum chamber to its original state with the cleaning plasma after having etched the magnetic film with the CO-containing plasma will be described below with reference to FIG. 7 and FIG. 8. Here, FIG. 7 illustrates a sequence chart of a conventional method of processing a magnetic film with a CO-containing plasma and a cleaning plasma; and FIG. 8 illustrates a schematic view of a representative example of a plasma etching apparatus with an inductively coupled type plasma source. The present process includes approximately the following ten steps.

In FIG. 7, the first step of Step S701 is a step of loading a wafer 802 to be etched having a magnetic film formed thereon, into a vacuum chamber 801 of which the condition has been controlled on a predetermined processing condition. At this time, the wafer 802 to be etched is placed on a wafer stage 803.

The second step of Step S702 is a step of supplying a CO-containing gas like a mixed gas of CO and NH₃ or CH₃OH into the vacuum chamber 801 from a gas introduction hole 804 only at a predetermined flow rate, adjusting a speed of exhausting the gas from an exhaust port 805 to thereby set the inner part of the vacuum chamber 801 at a predetermined pressure, and then applying a source electric power 806 to an antenna 807 to thereby convert the CO-containing gas which has been introduced into the vacuum chamber 801 into a plasma state. At this time, in order to facilitate the gas to be converted into the plasma state, a radio-frequency Faraday shield voltage 809 is applied to a Faraday shield 808 provided in the upper part of the vacuum chamber 801.

A third step of Step S703 is a step of etching a wafer to be etched, by using the CO-containing plasma generated in the second step. At this time, the pressure in the vacuum chamber 801 is set at a predetermined value, by adjusting a flow rate of the gas to be introduced into the vacuum chamber 801 from the gas introduction hole 804 and an exhaust speed of a gas to be exhausted from the exhaust port 805; and the source electric power 806 and the Faraday shield voltage 809 are set at predetermined values. In addition, a wafer bias electric power 810 is applied to the wafer 802 to be etched so as to actively draw ions in the plasma onto the wafer 802 to be etched.

The fourth step of Step S704 is a step of turning the source electric power 806, the Faraday shield voltage 809 and the wafer bias electric power 810 OFF, then stopping the supply of the CO-containing gas which is introduced from the gas introduction hole 804, and dissipating the CO-containing plasma.

The fifth step of Step S705 is a step of unloading the etched wafer 802 from the vacuum chamber 801.

The sixth step of Step S706 is a step of loading a cleaning wafer 811 for cleaning the inner part of the vacuum chamber 801 into the vacuum chamber 801. At this time, the cleaning wafer 811 is placed on the wafer stage 803.

The seventh step of Step S707 is a step of supplying a cleaning gas to be used for cleaning into the vacuum chamber 801 from the gas introduction hole 804 only at a predetermined flow rate, adjusting a speed of exhausting the gas from the exhaust port 805 to thereby set the inner part of the vacuum chamber 801 at a predetermined pressure, and then applying the source electric power 806 to the antenna 807 to thereby convert the cleaning gas which has been introduced into the vacuum chamber 801 into a plasma state. At this time, in order to facilitate the gas to be converted into the plasma state, a radio-frequency Faraday shield voltage 809 is applied to a Faraday shield 808 provided in the upper part of the vacuum chamber 801.

The eighth step of Step S708 is a step of cleaning the inner part of the vacuum chamber 801 by using the cleaning plasma which has been generated in the seventh step. At this time, the pressure in the vacuum chamber 801 is set at a predetermined value by adjusting a flow rate of the gas to be introduced into the vacuum chamber 801 from the gas introduction hole 804 and an exhaust speed of the gas to be exhausted from the exhaust port 805; and the source electric power 806 and the Faraday shield voltage 809 are set at predetermined values.

The ninth step of Step S709 is a step of turning the source electric power 806 and the Faraday shield voltage 809 OFF, then stopping the supply of the cleaning gas which is introduced from the gas introduction hole 804, and dissipating the cleaning plasma.

The tenth step of Step S710 is a step of unloading the cleaning wafer 811 which has been loaded for cleaning from the vacuum chamber 801.

By conducting such a sequence, the wafer 802 to be etched can be processed with the CO-containing plasma, and even when the C has deposited on the inner wall of the vacuum chamber 801 while the wafer 802 to be etched is processed, the C can be removed with the subsequent cleaning plasma. Thereby, the condition of the vacuum chamber 801 can be returned to the state before the CO-containing gas is converted into the plasma state, and another wafer 802 to be etched can be sequentially processed on the same condition by using a CO-containing plasma.

However, as a result of having conducted the sequence described in FIG. 7 and FIG. 8 using the CO-containing plasma, the magnetic film on the wafer 802 to be etched could be processed into a desired shape, but it has been found that it is difficult to convert the cleaning gas into the plasma state shown in the seventh step, and that it becomes difficult to clean the inner part of the vacuum chamber 801 with the cleaning plasma though depending on conditions. As the representative examples, FIG. 9 illustrates a result of having generated plasma as the CO-containing plasma by using a mixed gas of CO and NH₃, having generated plasma using O₂ gas as the cleaning plasma, having changed a gas ratio of CO and NH₃, in the second step of converting the CO-containing gas into the plasma state and in the third step of etching an object to be etched with the CO-containing plasma, and having measured a generation rate of the cleaning plasma. Here, the generation rate was calculated by conducting the steps from the first to fifth steps in FIG. 7, then repeating the step of converting the cleaning gas into the plasma state in the sixth step on the same condition until the cleaning gas is converted into the plasma state, and using the following expression on the basis of the obtained repeat number.

Generation rate of cleaning plasma(%)=1/(number of times of having repeatedly converted cleaning gas into plasma state)×100

The generation rate described in FIG. 9 is an average value of the generation rates obtained by conducting the similar sequence 3 times. In addition, in the present measurement, an inductively coupled type plasma source is used of which the sectional view is illustrated in FIG. 8, alumina was used as a material of the vacuum chamber 801, and the test was conducted on the following conditions.

[Condition of Conversion of CO-Containing Gas into Plasma State]

Total gas flow rate of CO and NH₃: 60 sccm (standard cc per minutes) Pressure in vacuum chamber: 2.0 Pa

Source electric power: 1,200 W Faraday shield voltage: 600 V Wafer bias electric power: 0 W

[Condition of Etching with CO-Containing Plasma]

Total gas flow rate of CO and NH₃: 60 sccm Pressure in vacuum chamber: 0.3 Pa Source electric power: 1,200 W

Faraday shield voltage: 100 V Wafer bias electric power: 100 W

### [Condition of Dissipation of CO-Containing Plasma]

Total gas flow rate of CO and NH₃: 0 sccm Pressure in vacuum chamber: 0.001 Pa Source electric power: 0 W

Faraday shield voltage: 0 V Wafer bias electric power: 0 W

[Condition of Conversion of Cleaning Gas into Plasma State]

O₂ gas flow rate: 60 sccm Pressure in vacuum chamber: 2.0 Pa Source electric power: 1,200 W

Faraday shield voltage: 600 V Wafer bias electric power: 0 W

### [Condition of Cleaning]

O₂ gas flow rate: 60 sccm Pressure in vacuum chamber: 1.0 Pa Source electric power: 1,200 W

Faraday shield voltage: 600 V Wafer bias electric power: 0 W

### [Condition of Dissipation of Cleaning Plasma]

O₂ gas flow rate: 0 sccm Pressure in vacuum chamber: 0.001 Pa Source electric power: 0 W

Faraday shield voltage: 0 V Wafer bias electric power: 0 W

As is illustrated in FIG. 9, as the CO ratio increases, the rate at which the cleaning plasma is generated decreases, and it becomes difficult to generate the plasma for conducting the cleaning. This is because the C-based deposit hinders the generation of plasma, which has deposited on the inner wall of the vacuum chamber 801 while the wafer is etched with the CO-containing plasma.

According to the Paschen's law which specifies a voltage necessary for starting an electric discharge, the voltage in starting the electric discharge is defined by the following expression.

$$Vs = \frac{Bpd}{ln ( Apd ) - ln ln ( 1 + 1 \text{/} γ )} \qquad [ Expression 1 ]$$

Here, Vs represents the voltage in starting the electric discharge, and in order to stably generate the plasma, a voltage equal to or higher than this voltage in starting the electric discharge needs to be applied to the vacuum chamber 801. In the present experiment, in order to stably apply the voltage equal to or higher than the voltage in starting the electric discharge to the inner wall of the vacuum chamber 801, a voltage of 600 V is applied to the Faraday shield 808 when the CO-containing gas and the cleaning gas are converted into the plasma state. In addition, A and B represent constants inherent to a gas, p represents a pressure against the inner wall of a vacuum chamber 801, and d represents a constant on the basis of a shape of a vacuum chamber 801. These values become the same, when the species and the pressure of the gas to be introduced into the vacuum chamber 801, and the inner shape of the vacuum chamber 801 are the same. On the other hand, γ represents a coefficient of secondary electron emission, and depends on the state of the inner wall of the vacuum chamber 801. As this value becomes lower, the voltage in starting the electric discharge becomes higher.

In other words, while the wafer is etched with the CO-containing plasma, the value of γ is lowered by the C-based deposit which has deposited on the inner wall of the vacuum chamber 801, and the voltage in starting the electric discharge for generating the cleaning plasma increases, which has resulted in being incapable of stably generating the plasma.

FIG. 10 illustrates values obtained by actually using the same condition as in the FIG. 9 and having measured the change of the film thickness of the C-based deposit which has deposited on the inner wall of the vacuum chamber 801, on the basis of a flow rate of CO/NH₃, after having conducted the steps of “converting CO-containing gas into plasma state”, “etching of the object with CO-containing plasma” and “dissipation of CO-containing plasma”. It is understood from the present figure that as the flow rate of the CO increases, the film thickness of the C-based deposit increases, and tendencies in FIG. 9 and FIG. 10 have a correlation. For information, it is confirmed by a surface composition analysis using XPS (X-ray photoelectron Spectroscopy) that the main component of the deposit which has been measured in FIG. 10 is C.

In order to stably clean the inner wall, only such a condition that the generation rate of the cleaning plasma becomes 100% needs to be used as the conditions on which the CO-containing gas is converted into the plasma state and the object is etched, but the need results in limiting a process window in which processing is possible.

It has been found that the similar phenomenon occurs also in the case where CH₃OH has been used as the CO-containing plasma, the generation rate becomes lower than 100% according to the source electric power 806 and the pressure, and accordingly the decrease of the generation rate of the cleaning plasma is a problem specific to the CO-containing plasma. In addition, the present experiment was conducted by using an inductively coupled type plasma source, but it is theoretically considered that a similar phenomenon occurs also when another plasma source is used.

An object of the present invention is to provide a method for stably generating the cleaning plasma regardless of a condition of CO-containing plasma.

### SUMMARY OF THE INVENTION

In order to solve the above described problems, the plasma etching method of the present invention employed the following technical means.

Specifically, the plasma etching method according to the present invention, in the case where a carbon deposit is produced in a vacuum chamber when a material to be etched is etched, includes: etching the material to be etched; then switching a gas from an etching gas for etching the material to be etched to a cleaning gas for removing the carbon deposit in a state of having kept s plasma state; and removing the carbon which has deposited in the vacuum chamber.

The plasma etching method according to the present invention further includes etching a magnetic film which has been formed on a wafer to be etched, with the etching gas.

The plasma etching method according to the present invention further includes: selecting a combustible gas or an inert gas as the cleaning gas, when having employed the combustible gas as the etching gas; and selecting a combustible gas, a combustion-supporting gas or an inert gas as the cleaning gas, when having employed the inert gas as the etching gas.

The plasma etching method according to the present invention further includes switching the gas from the etching gas to the cleaning gas by starting the introduction of the cleaning gas into the vacuum chamber while supplying the etching gas into the vacuum chamber in a state of applying a source electric power to an antenna after having etched the material to be etched; then stopping the introduction of the etching gas; stopping the application of a wafer bias electric power to the wafer simultaneously with the introduction of the cleaning gas; and switching the gas while keeping the plasma state.

The plasma etching method according to the present invention further includes: applying a source electric power to a CO-containing gas containing elements of C and O, which has been introduced into the vacuum chamber, to convert the CO-containing gas into the plasma state; etching the magnetic film formed on the wafer to be etched with the generated CO-containing plasma; processing the magnetic film formed on the wafer to be etched with the CO-containing plasma; then introducing the cleaning gas into the vacuum chamber in a state of applying the source electric power to the antenna; and then stopping the introduction of the CO-containing gas into the vacuum chamber to thereby generate a cleaning plasma with the use of a cleaning gas containing the O element or an H element.

The plasma etching method according to the present invention further includes: switching the gas from the etching gas for etching the material to be etched to a rare gas in a state of having kept the plasma state, after having etched the material to be etched; and then switching the gas from the rare gas to the cleaning gas for removing the carbon deposit in the state of having kept the plasma state.

The plasma etching method according to the present invention further includes switching the gas from the etching gas to the rare gas and then further to the cleaning gas by: starting the introduction of the rare gas into the vacuum chamber while supplying the etching gas into the vacuum chamber in a state of applying a source electric power to an antenna after having etched the material to be etched; then stopping the introduction of the etching gas; starting the introduction of the cleaning gas while supplying the rare gas into the vacuum chamber in a state of applying the source electric power to the antenna; then stopping the introduction of the rare gas; stopping the application of a wafer bias electric power to the wafer simultaneously with the introduction of the cleaning gas; and thus switching the gas while keeping the plasma state.

The plasma etching method according to the present invention further includes: applying a source electric power to a combustible CO-containing gas containing elements of C and O, which has been introduced into the vacuum chamber, to convert the CO-containing gas into a plasma state; etching the magnetic film formed on the wafer to be etched with the generated CO-containing plasma; processing the magnetic film formed on the wafer to be etched with the plasma of the gas that contains CO and contains the combustible gas; introducing a rare gas and N₂ gas into the vacuum chamber in a state of applying the source electric power; then stopping the introduction of the gas that contains CO and contains the combustible gas; further introducing a cleaning gas containing a combustion-supporting gas; then stopping the introduction of the rare gas and N₂ gas; and thereby generating cleaning plasma using the cleaning gas containing the combustion-supporting gas.

When a magnetic film formed on a wafer to be etched is processed with a CO-containing gas, there is the case where a C-based deposit that has been produced during etching deposits on the inner wall of a vacuum chamber, thereby results in hindering a cleaning gas from being converted into a plasma state, and disables the inner part of the vacuum chamber to be cleaned. However, according to the present invention, a cleaning plasma can be generated by introducing a cleaning gas while the plasma state is kept after the wafer to be etched has been processed with the CO-containing gas, even without needing a step of converting the cleaning gas into the plasma state, and the inner wall of the vacuum chamber can be stably cleaned regardless of the condition of the CO-containing plasma.

### BRIEF DESCRIPTION OF THE DRAWINGS

FIG. 1 is a sequence chart of a method of processing a magnetic film with a CO-containing plasma and a cleaning plasma according to a first exemplary embodiment of the present invention;

FIG. 2 is a time chart of a CO-containing gas, a cleaning gas, a source electric power 806 and a wafer bias electric power 810 according to the first exemplary embodiment of the present invention;

FIG. 3 is a view illustrating values obtained by using plasma generated from a mixed gas of CO and NH₃ as a CO-containing plasma and plasma generated from O₂ gas as a cleaning plasma, changing a mixture ratio of CO to NH₃ while using the first exemplary embodiment, and having measured a generation rate of a cleaning plasma;

FIG. 4 is a classification table of gas species to be used for an etching gas and a cleaning gas;

FIG. 5 is a sequence chart of a method of processing a magnetic film with plasma of a CO-containing gas containing a combustible gas and cleaning plasma containing a combustion-supporting gas according to a second exemplary embodiment of the present invention;

FIG. 6 is a time chart of a CO-containing gas, a cleaning gas, a rare gas, an N₂ gas and a source electric power 806 according to the second exemplary embodiment of the present invention;

FIG. 7 is a sequence chart of a method of processing a magnetic film with a CO-containing plasma and a cleaning plasma in a conventional example;

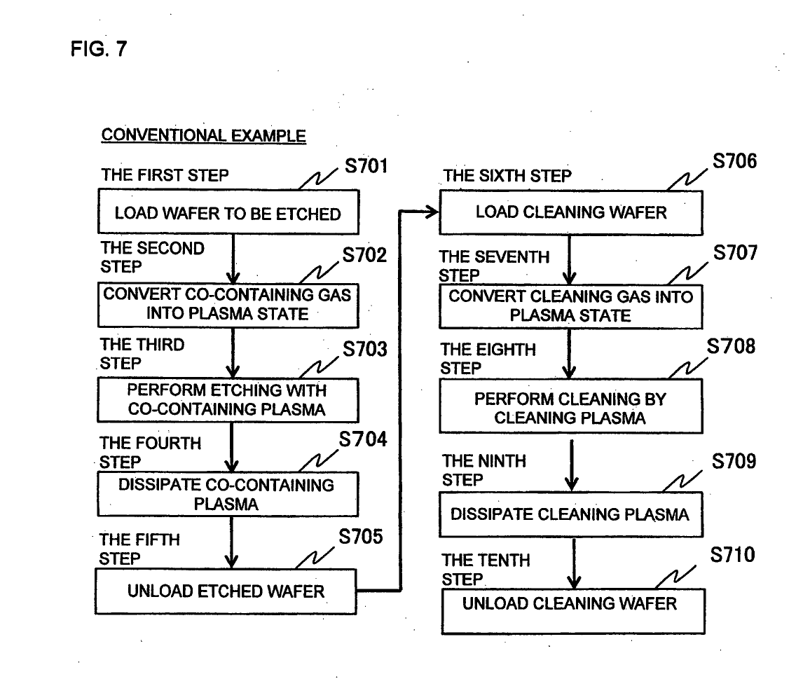

FIG. 8 is a schematic view of an experimental apparatus used in the present experiment;

FIG. 9 is a view illustrating values obtained by using plasma generated from a mixed gas of CO and NH₃ as a CO-containing plasma, and plasma generated from O₂ gas as a cleaning plasma, changing a mixture ratio of CO to NH₃ while using a method of the conventional example, and having measured a generation rate of the cleaning plasma; and

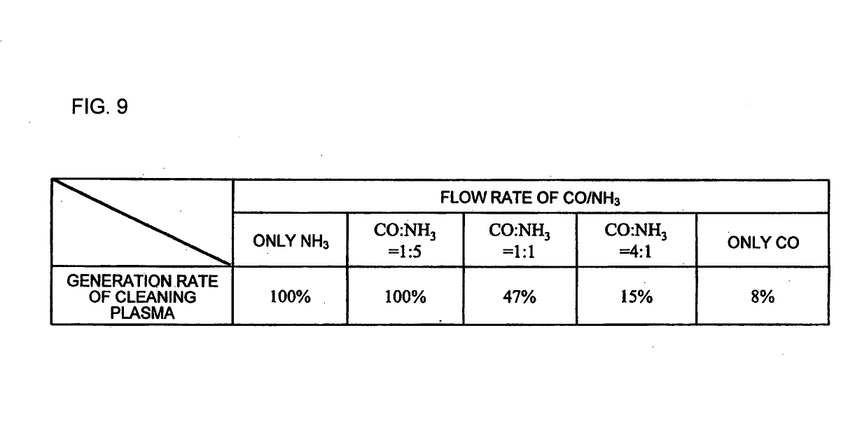

FIG. 10 is a view illustrating values obtained by having measured a change of the film thickness of a C-based deposit which has deposited on the inner wall of a vacuum chamber 801, with respect to a flow rate of CO/NH₃.

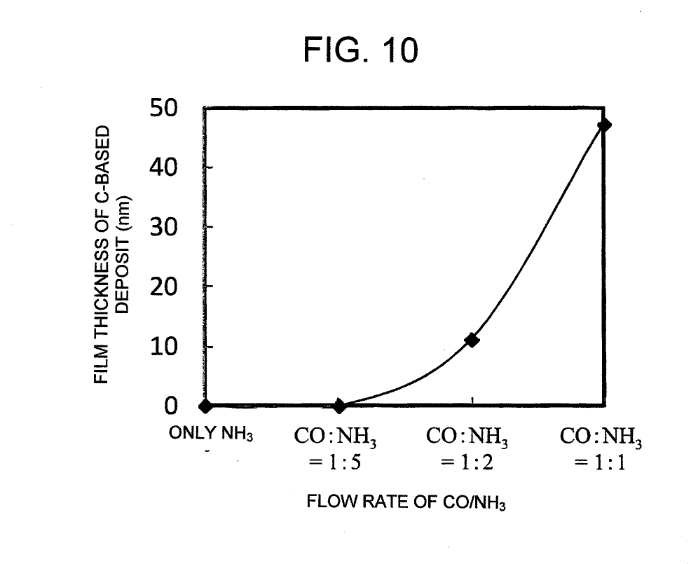

### DETAILED DESCRIPTION OF THE PREFERRED EMBODIMENTS

Embodiments according to the present invention will be described below with reference to the drawings.

### Exemplary Embodiment 1

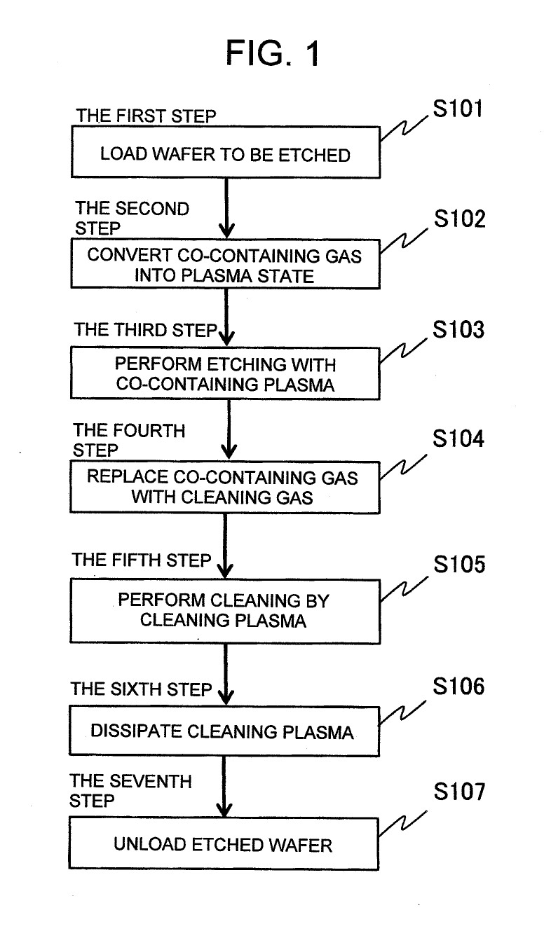

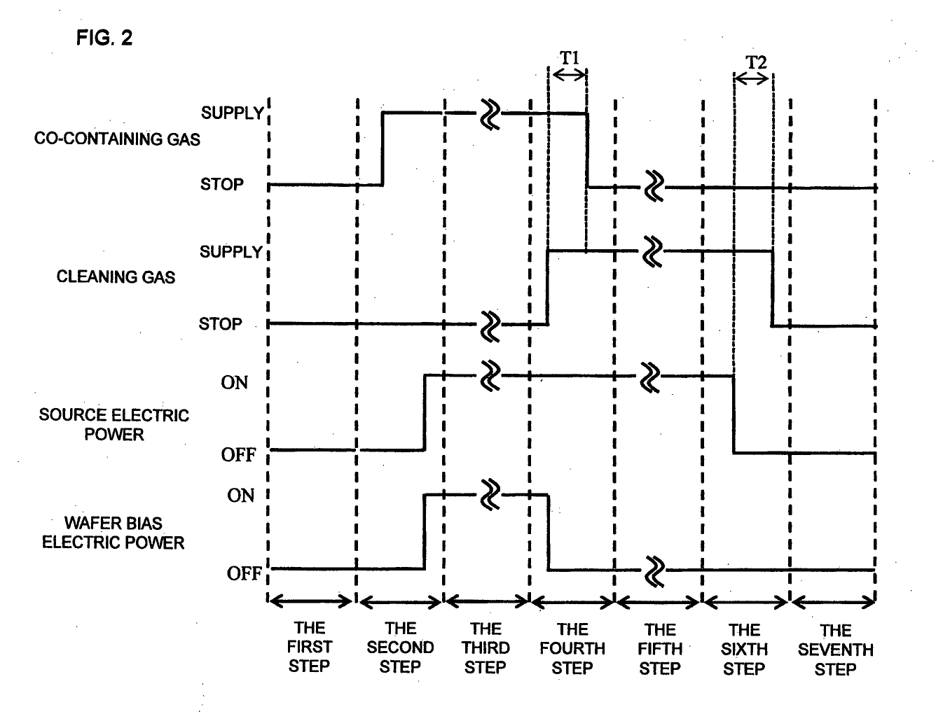

The first exemplary embodiment for carrying out the present invention will be described below with reference to FIG. 1 and FIG. 2. FIG. 1 is a sequence chart of a method of processing a magnetic film with a CO-containing plasma and a cleaning plasma; and FIG. 2 illustrates a time chart of a CO-containing gas, a cleaning gas and a source electric power 806 when the sequence of FIG. 1 is conducted. The present sequence includes approximately the following seven steps.

In FIG. 1, the first step of Step S101 is a step of loading a wafer 802 to be etched having a magnetic film containing an element such as Fe, Co and Ni formed thereon, into a vacuum chamber 801 of which the condition has been controlled on a predetermined processing condition. The predetermined processing condition in the present step means: an aging step of previously processing the vacuum chamber 801 until the temperature of the vacuum chamber 801 is saturated so as to reduce the fluctuation of the temperature of the vacuum chamber 801 during etching; a seasoning step of depositing a film on the inner wall of the vacuum chamber 801 so as to keep the state of the inner wall of the vacuum chamber 801 constant; and a cleaning step of removing the film which has deposited on the inner wall of the vacuum chamber 801. Processing conditions to be used in the steps, the type of the wafer to be used and the number of the wafers to be used are not limited in particular.

The second step of Step S102 is a step of starting the supply of a CO-containing gas into the vacuum chamber 801, setting the inner part of the vacuum chamber 801 at a predetermined pressure, and then turning a source electric power 806 and a wafer bias electric power 810 ON to thereby convert the CO-containing gas into a plasma state. The CO-containing gas means: a single gas containing elements of C and O such as CO, CO₂, COS, CH₃OH, C₂H₅OH, CH₃OCH₃ and CH₃COCH₃; and a mixed gas of a gas containing the elements of C and O with another gas, such as a mixed gas of CO and NH₃, a mixed gas of CO and H₂, a mixed gas of CO and H₂O, a mixed gas of CO and N₂, a mixed gas of CO and H₂ and a mixed gas of CO and a rare gas. As long as the CO-containing gas contains the elements of C and O, the species of the gas is not limited in particular. Incidentally, in the time chart of FIG. 2, the source electric power 806 and the wafer bias electric power 810 are simultaneously turned ON, but the wafer bias electric power 810 may be turned ON after the source electric power 806 has been turned ON, or the source electric power 806 may be turned ON after the wafer bias electric power 810 has been turned ON.

The third step of Step S103 is a step of subjecting a magnetic film containing an element such as Fe, Co and Ni formed on the wafer 802 to be etched to predetermined etching with the use of the CO-containing plasma generated in the second step. The pressure in the vacuum chamber 801 and the values of the source electric power 806 and the wafer bias electric power 810 may be changed in the second step and the third step, as needed, but the source electric power 806 must not be turned OFF. The ratio of gases in the CO-containing gas, the type of gases in the CO-containing gas and the flow rate of the CO-containing gas may be changed in the second step and the third step, as needed.

The fourth step of Step S104 is a step of starting the supply of a cleaning gas into the vacuum chamber 801, then stopping the introduction of the CO-containing gas into the vacuum chamber 801, and changing the gas in the vacuum chamber 801 to the cleaning gas from the CO-containing gas while maintaining the electric discharge. The pressure in the vacuum chamber 801 and the source electric power 806 may be changed in the third step and the fourth step, as needed, but the source electric power 806 must not be turned OFF in the third step and the fourth step, in order to maintain the electric discharge. The cleaning gas to be introduced in the fourth step is used for removing the C-based film which has deposited on the inner wall of the vacuum chamber 801 in the second step and the third step, and it is desirable to use a gas containing an O element like O₂ gas or a gas formed by mixing O₂ with a rare gas. However, it is known that the C-based film can be removed also by a reaction between itself and an H element, and it is acceptable to use a gas containing an H element like H₂ gas, H₂O gas, a gas formed by mixing H₂ with a rare gas, a gas formed by mixing H₂O with a rare gas or the like, as the cleaning gas.

In addition, in FIG. 2, the introduction of the CO-containing gas is stopped after the time T1 has passed from the time when the supply of the cleaning gas in the fourth step has been started, but because a residence time of the gas in the vacuum chamber 801 is several tens ms to several hundreds ms, the gas stays in the vacuum chamber 801 and plasma does not dissipate, even if the introduction of the CO-containing gas is stopped at the same time when the supply of the cleaning gas starts. However, when the supply of the cleaning gas is started after the introduction of the CO-containing gas has been stopped, a gas for generating the plasma in the vacuum chamber 801 disappears and the plasma dissipates. Accordingly, in order to prevent the dissipation of the plasma, it is desirable that the time T1 is 0 second or longer. In addition, the inner part of the vacuum chamber 801 cannot be sufficiently cleaned while both of the CO-containing gas and the cleaning gas are introduced into the vacuum chamber 801. Accordingly, the time T1 is preferably short, and the time T1 is desirably set within 5 seconds as much as possible. Therefore, the value of the time T1 is desirably set at 0 second or longer and 5 seconds or shorter.

In the fourth step, the wafer bias electric power 810 is desirably turned OFF simultaneously with the introduction of the cleaning gas, in order to reduce a damage that the etched wafer 802 may receive from ions in the cleaning gas, which are incident on the wafer. However, the wafer bias electric power 810 may also be kept ON when the film on the etched wafer 802 is also desired to be actively cleaned. At this time, the value of the wafer bias electric power 810 may also be changed in the third step and the fourth step, as needed.

The fifth step of Step S105 is a step of removing the C-based film which has deposited on the inner wall of the vacuum chamber 801 with a cleaning plasma that has been generated by using the cleaning gas. The pressure in the vacuum chamber 801 and the source electric power 806 may also be changed in the fourth step and the fifth step, as needed. The wafer bias electric power 810 is desirably turned OFF in order to reduce the damage that the etched wafer 802 may receive from ions in the cleaning gas, which are incident on the wafer, but it is acceptable to turn the wafer bias electric power 810 ON and to supply a predetermined value of the electric power to the wafer, when the film on the etched wafer 802 also is desired to be actively cleaned.

The sixth step of Step S106 is a step of turning the source electric power 806 and the wafer bias electric power 810 OFF, then stopping the introduction of the cleaning gas which is introduced in the vacuum chamber 801, and then exhausting the cleaning gas in the vacuum chamber 801 to thereby dissipate the cleaning plasma. In FIG. 2, the introduction of the cleaning gas is stopped after the time T2 has passed from the time when the source electric power 806 in the sixth step has been turned OFF, but because a residence time of the gas in the vacuum chamber 801 is several tens ms to several hundreds ms, the gas stays in the vacuum chamber 801 and the plasma does not dissipate, even if the supply of the cleaning gas is stopped at the same time when the source electric power 806 is turned OFF. However, when the source electric power 806 is turned OFF after the supply of the cleaning gas has been stopped, the source electric power 806 results in being applied to the antenna in a state in which there is no gas for generating the plasma in the vacuum chamber 801, a load is applied to a power source for supplying the source electric power 806 to the antenna, and the power source possibly suffers a breakdown. Because of this, the time T2 is desirably 0 second or longer.

A seventh step of Step S107 is a step of unloading the etched wafer 802 for which the predetermined processing has been completed from the vacuum chamber 801.

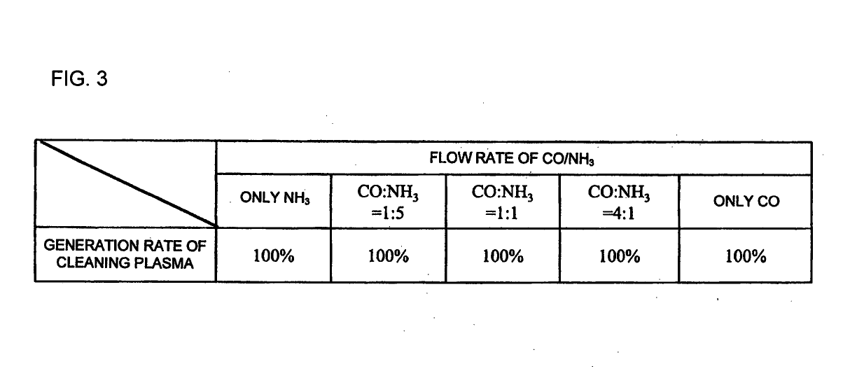

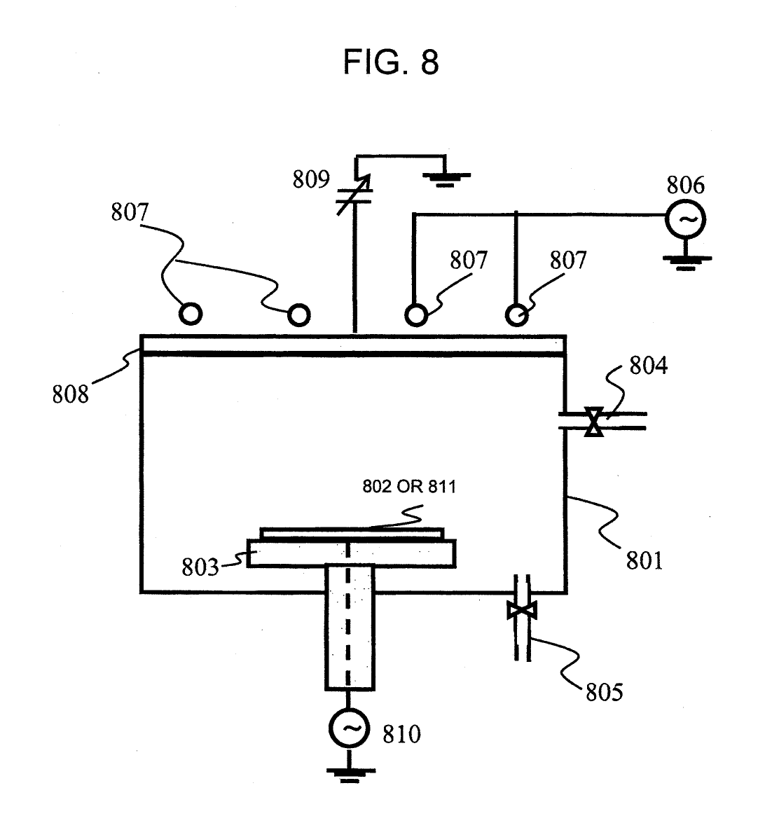

As a result of having conducted the experiment on the following condition while using such an actual wafer that a magnetic film (CoFeB) is formed on an Si substrate of the wafer 802 to be etched, and using an etching apparatus of which the schematic view is illustrated in FIG. 8, the magnetic film could be processed into a predetermined shape, and it was confirmed that the cleaning plasma could be generated at an ignition rate of 100% regardless of a gas ratio as is illustrated in FIG. 3. For information, CO and NH₃ used for generating the CO-containing plasma are combustible gases, and O₂ used for generating the cleaning plasma is a combustion-supporting gas. Accordingly, there is a risk of causing explosion in an exhaust side when the gases are mixed. Because of this, the experiment was conducted in a state of diluting the exhaust gas to the explosion limit or lower by always passing N₂ of 10,000 sccm or more to an exhaust port 805 during the processing.

[Condition of Conversion of CO-Containing Gas into Plasma State]

Total gas flow rate of CO and NH₃: 60 sccm (standard cc per minutes) Pressure in vacuum chamber: 2.0 Pa

Source electric power: 1,200 W Faraday shield voltage: 600 V Wafer bias electric power: 0 W

[Condition of Etching with CO-Containing Plasma]

Total gas flow rate of CO and NH₃: 60 sccm Pressure in vacuum chamber: 0.3 Pa Source electric power: 1,200 W

Faraday shield voltage: 100 V Wafer bias electric power: 100 W

[Condition of Replacing CO-Containing Gas with Cleaning Gas]

Total gas flow rate of CO and NH₃: 60 sccm O₂ gas flow rate: 60 sccm Pressure in vacuum chamber: 1.0 Pa

Source electric power: 1,200 W Faraday shield voltage: 100 V Wafer bias electric power: 0 W

### [Condition of Cleaning]

O₂ gas flow rate: 60 sccm Pressure in vacuum chamber: 1.0 Pa Source electric power: 1,200 W

Faraday shield voltage: 600 V Wafer bias electric power: 0 W

### [Condition of Dissipation of Cleaning Plasma]

O₂ gas flow rate: 0 sccm Pressure in vacuum chamber: 0.001 Pa Source electric power: 0 W

Faraday shield voltage: 0 V Wafer bias electric power: 0 W

From the above description, when the magnetic film containing the element such as Fe, Co and Ni formed on the wafer 802 to be etched is processed with the CO-containing gas, the C-based deposit which has been generated during etching deposits on the inner wall of the vacuum chamber 801, thereby results in hindering the cleaning gas from being converted into the plasma state, and occasionally disables the cleaning plasma to be generated and the inner part of the vacuum chamber 801 to be cleaned. However, by conducting the seven steps illustrated in FIG. 1 and FIG. 2, it has become possible to introduce the cleaning gas while keeping the plasma state after having processed the magnetic film formed on the etched wafer 802 with the CO-containing plasma, and the cleaning plasma can be stably generated regardless of the condition of the CO-containing plasma by generating the cleaning plasma even without needing a step of converting the cleaning gas into the plasma state.

In the steps from the fourth step of Step S104 to the sixth step of Step S106, a processing period of time for the C-based deposit which has deposited on the inner wall of the vacuum chamber 801 with the cleaning plasma when removing the deposit is not specified in particular, but the total processing period of time in the steps from the fourth step to the sixth step is desirably set at 3 seconds or longer so as to sufficiently clean the C-based deposit which has deposited on the inner wall of the vacuum chamber 801 with the cleaning plasma generated by using a gas containing an O element or a gas containing an H element. In addition, when the etched wafer 802 has been exposed to the cleaning plasma generated by using the gas containing the O element or the gas containing the H element for a long period of time, a film formed on the etched wafer 802 possibly receives a damage due to the plasma, and accordingly the total period of processing time in the steps from the fourth step to the sixth step is desirably set at 120 seconds or shorter.

In addition, in the exemplary embodiment illustrated in FIG. 3, CO and NH₃ which are combustible gases were used for generating the CO-containing plasma, and O₂ which is a combustion-supporting gas was used for generating the cleaning plasma, but when the combustible gas and the combustion-supporting gas were mixed and passed to an exhaust side, there is a risk of causing explosion in the exhaust side. Because of this, when the fourth step (replacing CO-containing gas with cleaning gas) in FIG. 1 and FIG. 2 is conducted, the experiment needed to be conducted in the state of having diluted the exhaust gas to the explosion limit or lower by always passing N₂ to an exhaust port in order to suppress the explosion due to the mixing of the combustible gas with the combustion-supporting gas.

On the other hand, even when the combustible gas is used for generating the CO-containing plasma, if the combustible gas or an inert gas is used for generating the cleaning plasma, the risk of causing the explosion is eliminated, and the exhaust gas does not need to be diluted by N₂. In addition, when the inert gas is used for generating the CO-containing plasma, even if the combustible gas, the combustion-supporting gas or the inert gas is used for generating the cleaning plasma, there is no risk of causing explosion, and the exhaust gas does not need to be diluted by N₂.

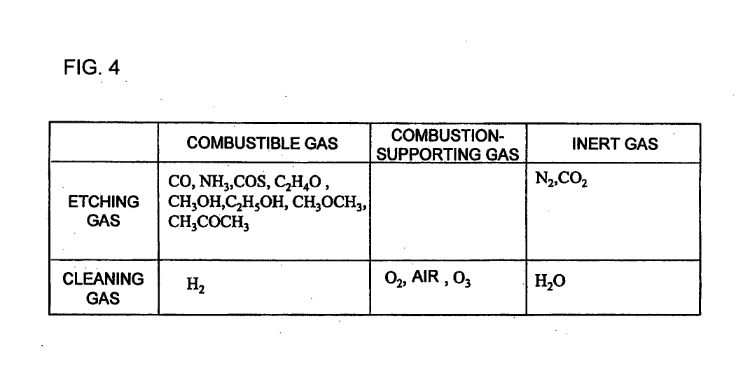

In other words, in a matrix table illustrating the classification of the combustible gas, the combustion-supporting gas and the inert gas of FIG. 4, when the combustible gas is used as the CO-containing gas, the present exemplary embodiment can be conducted without the risk of causing explosion by selecting an combustible gas or an inert gas as the cleaning gas and using the selected gas. In addition, when the inert gas is used as the CO-containing gas, the present exemplary embodiment can be conducted without the risk of causing explosion, by using the combustible gas, the combustion-supporting gas or the inert gas as the cleaning gas.

### Exemplary Embodiment 2

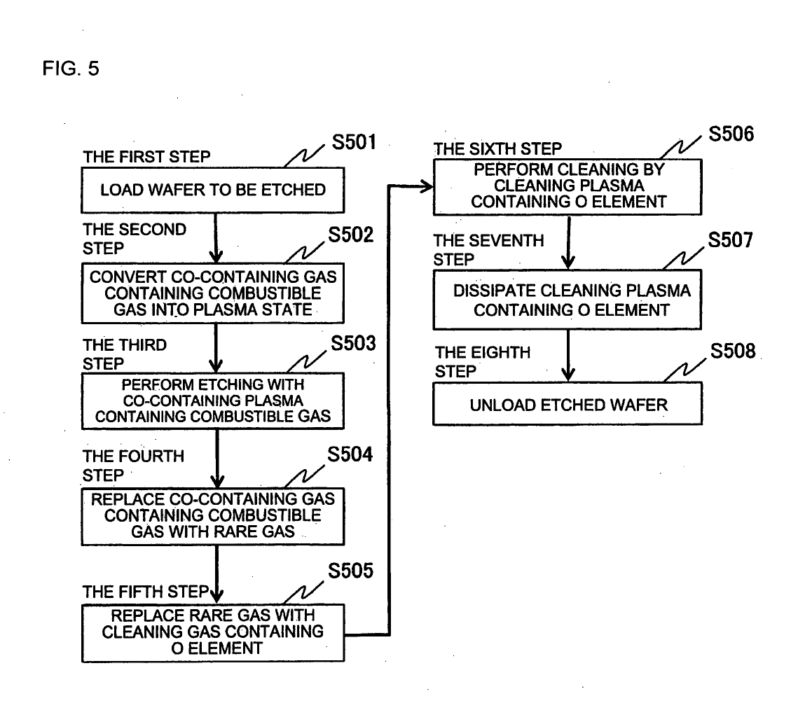

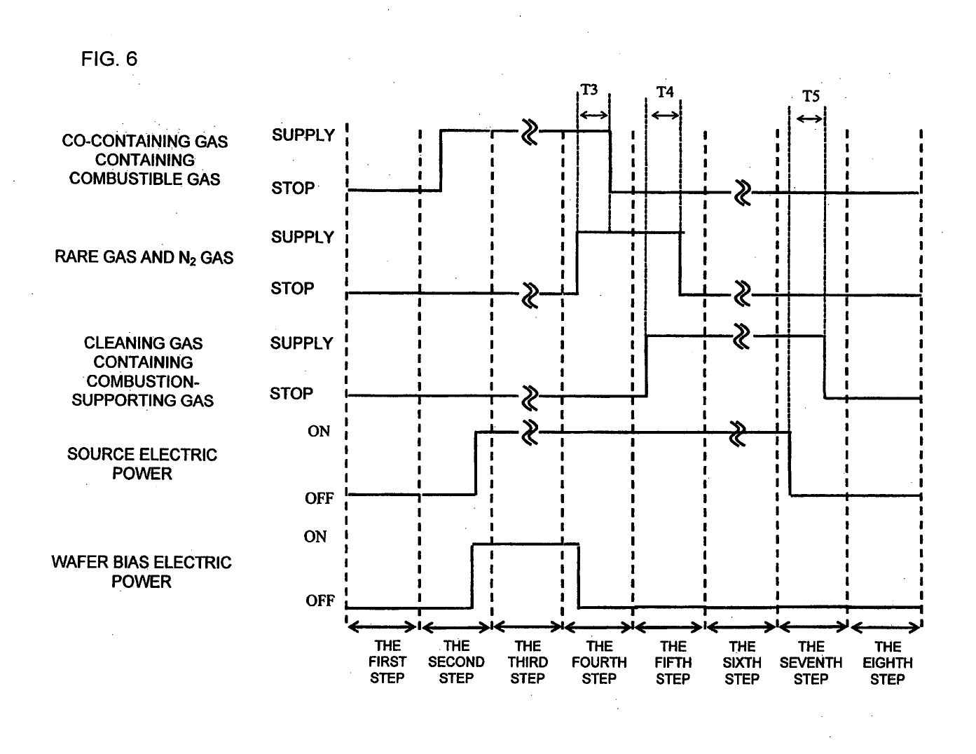

The second exemplary embodiment for carrying out the present invention will be described with reference to FIG. 5 and FIG. 6. FIG. 5 is a sequence chart of a method for processing a magnetic film by using CO-containing plasma generated by using a CO-containing gas containing a combustible gas, and cleaning plasma generated by using a cleaning gas containing a combustion-supporting gas; and FIG. 6 shows a time chart of the CO-containing gas, a rare gas, the cleaning gas and a source electric power 806 which are used when the sequence of FIG. 5 is conducted. The present sequence includes approximately the following eight processes.

In FIG. 5, the first step of Step S501 is a step of loading a wafer 802 to be etched having a magnetic film containing an element such as Fe, Co and Ni formed thereon, into a vacuum chamber 801 of which the condition has been controlled on a predetermined processing condition. The predetermined processing condition in the present step includes: an aging step of previously processing the vacuum chamber 801 until the temperature of the vacuum chamber 801 is saturated so as to reduce the fluctuation of the temperature of the vacuum chamber 801 during etching; a seasoning step of depositing a film on the inner wall of the vacuum chamber 801 so as to keep the state of the inner wall of the vacuum chamber 801 constant; and a cleaning step of removing the film which has deposited on the inner wall of the vacuum chamber 801. Processing conditions to be used in the steps, the type of the wafer to be used and the number of the wafers to be used are not limited in particular.

The second step of Step S502 is a step of starting the supply of a CO-containing gas containing the combustible gas into the vacuum chamber 801 and setting the inner part of the vacuum chamber 801 at a predetermined pressure, and then turning a source electric power 806 and a wafer bias electric power 810 ON to thereby convert the CO-containing gas containing the combustible gas into a plasma state. The CO-containing gas containing the combustible gas means: a combustible single gas containing elements of C and O such as CO, COS, C₂H₄O, CH₃OH, C₂H₅OH, CH₃OCH₃ and CH₃COCH₃; and a mixed gas of a gas containing the elements of C and O with another gas, such as a mixed gas of CO and NH₃, a mixed gas of CO and H₂, a mixed gas of CO and H₂O, a mixed gas of CO and N₂, a mixed gas of CO and H₂ and a mixed gas of CO and a rare gas. As long as the CO-containing gas containing the combustible gas contains the elements of C and O, the species of the gas is not limited in particular. Incidentally, in the time chart of FIG. 6, the source electric power 806 and the wafer bias electric power 810 are simultaneously turned ON, but the wafer bias electric power 810 may be turned ON after the source electric power 806 has been turned ON, or the source electric power 806 may be turned ON after the wafer bias electric power 810 has been turned ON.

The third step of Step S503 is a step of subjecting a magnetic film formed on the wafer 802 to be etched to predetermined etching with the use of the CO-containing plasma generated by using the gas containing the combustible gas in the second step. The pressure in the vacuum chamber 801 and the values of the source electric power 806 and the wafer bias electric power 810 may be changed in the second step and the third step, as needed, but the source electric power 806 must not be turned OFF. In addition, the ratio of gases in the CO-containing gas containing the combustible gas, the type of gases in the CO-containing gas and the flow rate of the CO-containing gas may be changed in the second step and the third step, as needed.

The fourth step of Step S504 is a step of starting the supply of the rare gas such as He, Ne, Ar, Kr and Xe and N₂ gas into the vacuum chamber 801, then stopping the introduction of the CO-containing gas containing the combustible gas into the vacuum chamber 801, and changing the gas in the vacuum chamber 801 to the rare gas and N₂ gas from the CO-containing gas while maintaining the electric discharge. The pressure in the vacuum chamber 801 and the source electric power 806 may be changed in the third step and the fourth step, as needed, but the source electric power 806 must not be turned OFF in the third step and the fourth step, in order to maintain the electric discharge.

In FIG. 6, the introduction of the CO-containing gas is stopped after the time T3 has passed from the time when the supply of the rare gas and N₂ gas in the fourth step has been started, but because a residence time of the gas in the vacuum chamber 801 is several tens ms to several hundreds ms, the gas stays in the vacuum chamber 801 and plasma does not dissipate, even if the introduction of the CO-containing gas is stopped at the same time when the supply of the rare gas and N₂ gas starts. However, when the supply of the rare gas and N₂ gas is started after the introduction of the CO-containing gas has been stopped, a gas for generating the plasma in the vacuum chamber 801 disappears and the plasma dissipates. Because of this, the time T3 is desirably 0 second or longer. In the fourth step, the wafer bias electric power 810 is desirably turned OFF simultaneously with the introduction of the rare gas and N₂ gas, in order to reduce a damage that the etched wafer 802 may receive from ions in the rare gas and N₂ gas, which are incident on the wafer.

The fifth step of Step S506 is a step of starting the supply of the cleaning gas containing the combustion-supporting gas into the vacuum chamber 801, then stopping the introduction of the rare gas and N₂ gas into the vacuum chamber 801, and changing the gas in the vacuum chamber 801 from the rare gas and N₂ gas to the cleaning gas containing the combustion-supporting gas while maintaining the electric discharge. The pressure in the vacuum chamber 801 and the source electric power 806 may also be changed in the fourth and the fifth step, as needed, but the source electric power 806 must not be turned OFF in the fourth and the fifth step, in order to maintain the electric discharge. In addition, the cleaning gas containing the combustion-supporting gas to be introduced in the fifth step is used for removing a C-based film which has deposited on the inner wall of the vacuum chamber 801 in the second and third steps.

In FIG. 6, the introduction of the rare gas and N₂ gas is stopped after the time T4 has passed from the time when the supply of the cleaning gas in the fifth step has been started, but because the residence time of the gas in the vacuum chamber 801 is several tens ms to several hundreds ms, the gas stays in the vacuum chamber 801 and the plasma does not dissipate, even if the introduction of the rare gas and N₂ gas is stopped at the same time when the supply of the cleaning gas starts. However, when the supply of the cleaning gas is started after the introduction of the rare gas and N₂ gas has been stopped, a gas for generating the plasma in the vacuum chamber 801 disappears and the plasma dissipates. Because of this, the time T4 is desirably 0 second or longer.

In addition, in the fifth step of Step S505, the wafer bias electric power 810 is desirably turned OFF in order to reduce a damage that the etched wafer 802 may receive from ions in the cleaning gas, which are incident on the wafer. However, it is acceptable to turn the wafer bias electric power 810 ON and to supply a predetermined value of an electric power to the wafer, when the film on the etched wafer 802 also is desired to be actively cleaned.

The sixth step of Step S506 is a step of removing the C-based film which has deposited on the inner wall of the vacuum chamber 801 with a cleaning plasma that has been generated by using the cleaning gas containing the combustion-supporting gas. The pressure in the vacuum chamber 801 and the source electric power 806 may be changed in the fifth step and the sixth step, as needed. In addition, in the sixth step, the wafer bias electric power 810 is desirably turned OFF in order to reduce a damage that the etched wafer 802 may receive from ions in the cleaning gas, which are incident on the wafer, but it is acceptable to turn the wafer bias electric power 810 ON and to supply a predetermined value of an electric power to the wafer, when the film on the etched wafer 802 also is desired to be actively cleaned.

The seventh step of Step S507 is a step of turning the source electric power 806 and the wafer bias electric power 810 OFF, then stopping the introduction of the cleaning gas containing the combustion-supporting gas, which is introduced into the vacuum chamber 801, and exhausting the cleaning gas in the vacuum chamber 801 to thereby dissipate the cleaning plasma. In FIG. 6, the introduction of the cleaning gas is stopped after the time T5 has passed from the time when the source electric power 806 in the sixth step has been turned OFF, but because a residence time of the gas in the vacuum chamber 801 is several tens ms to several hundreds ms, the gas stays in the vacuum chamber 801 and the plasma does not dissipate, even if the supply of the cleaning gas is stopped at the same time when the source electric power 806 is turned OFF. However, when the source electric power 806 is turned OFF after the supply of the cleaning gas has been stopped, the source electric power 806 results in being applied to the antenna in a state in which there is no gas for generating the plasma in the vacuum chamber 801, a load is applied to a power source for supplying the source electric power 806 to the antenna, and the power source possibly suffers a breakdown. Because of this, the time T5 is desirably 0 second or longer.

The eighth step of Step S508 is a step of unloading the etched wafer 802 for which the predetermined processing has been completed from the vacuum chamber 801. When the combustible gas is used as the CO-containing gas and the combustion-supporting gas is used as the cleaning gas, and when the first exemplary embodiment shown in FIG. 1 and FIG. 2 has been used, the CO-containing gas containing the combustible gas and the cleaning gas containing the combustion-supporting gas are mixed at the exhaust side of the vacuum chamber 801 in the fourth step of FIG. 1 and FIG. 2, and there is a risk of causing explosion in the exhaust side unless the exhausted gas is diluted with a gas such as N₂ gas. However, by using the above described second exemplary embodiment, it becomes possible to change the CO-containing gas containing the combustible gas to the rare gas and N₂ gas in the fifth step of FIG. 5 and FIG. 6, and it also becomes possible to change the rare gas and N₂ gas to the cleaning gas containing the combustion-supporting gas in the fifth step of FIG. 5 and FIG. 6. Accordingly, it is possible to generate the cleaning plasma without needing a step of converting the cleaning gas into the plasma state in a state of having prevented the mixing of the CO-containing gas containing the combustible gas with the cleaning gas containing the combustion-supporting gas, the cleaning plasma is stably generated regardless of conditions of the CO-containing plasma, and the risk of causing the explosion is eliminated even without diluting the exhausted gas with the gas such as N₂ gas.

If a total period of the time of changing the CO gas containing the combustible gas to the rare gas and N₂ gas in the fourth step and the time of changing the rare gas and N₂ gas to the cleaning gas containing the combustion-supporting gas in the fifth step in FIG. 5 and FIG. 6 is too short, it is possible that the CO gas containing the combustible gas and the cleaning gas containing the combustion-supporting gas are mixed in the vacuum chamber 801. However, if the total period of time of the fourth step and fifth step is 1 s or longer, there is no possibility that the gases are mixed, because the average residence time in the vacuum chamber 801 is usually several tens ms to several hundreds ms. In addition, it is desirable to set the period of time of the fourth step and the fifth step to 30 seconds or shorter, because the etched wafer 802 possibly receives a damage by the rare gas if the period of time of the fourth step and the fifth step of FIG. 5 and FIG. 6 is too long.

Furthermore, in the steps from the fifth step of Step S505 to the seventh step of Step S507, the processing time of the cleaning plasma for removing the C-based deposit which has deposited on the inner wall of the vacuum chamber 801 is not specified in particular, but it is desirable to set the total period of processing time of the steps from the fifth step to the seventh step at 3 seconds or longer, in order to fully clean the C-based deposit which has deposited on the inner wall of the vacuum chamber 801 with the plasma generated by using the gas containing the combustion-supporting gas. In addition, when the etched wafer 802 has been exposed to the cleaning plasma generated by using the gas containing the combustion-supporting gas for a long period of time, the etched wafer 802 possibly receives a damage due to the plasma, and accordingly the total period of processing time of the steps from the fifth step to the seventh step is desirably set at 120 seconds or shorter.

As described above, according to the present invention, it is possible to generate the plasma for stably cleaning the inner wall of the vacuum chamber 801 after having conducted the step of processing the magnetic film by using the gas containing elements of C and O, and to remarkably enhance the production stability of the magnetic film used for a magnetic resistance memory and the like.

What is claimed is:

1. A plasma etching method in the case where a carbon deposit is produced in a vacuum chamber when an object to be processed is etched, comprising:
etching the object to be processed;
then switching a gas from an etching gas for etching the object to be processed to a cleaning gas for removing the carbon deposit in a state of having kept a plasma state; and
removing the carbon which has deposited in the vacuum chamber.

2. The plasma etching method according to claim 1, wherein
a magnetic film which has been formed on a wafer to be etched as the object to be processed is etched by the etching gas.

3. The plasma etching method according to claim 1, wherein
when a combustible gas is employed as the etching gas, a combustible gas or an inert gas is selected as the cleaning gas; and when an inert gas is employed as the etching gas, a combustible gas, a combustion-supporting gas or an inert gas is selected as the cleaning gas.

4. The plasma etching method according to claim 1, further comprising:
switching the gas from the etching gas to the cleaning gas by starting the introduction of the cleaning gas into the vacuum chamber while supplying the etching gas into the vacuum chamber in a state of applying a source electric power to an antenna after having etched a material to be etched;
then stopping the introduction of the etching gas; stopping the application of a wafer bias electric power to the wafer simultaneously with the introduction of the cleaning gas; and
thus switching the gas while keeping the plasma state.

5. The plasma etching method according to claim 2, further comprising:
applying a source electric power to a CO-containing gas containing elements of C and O, which has been introduced into the vacuum chamber, to convert the CO-containing gas into the plasma state;
etching the magnetic film formed on the wafer to be etched with the generated CO-containing plasma;
processing the magnetic film formed on the wafer to be etched with the CO-containing plasma;
then introducing the cleaning gas into the vacuum chamber in a state of applying the source electric power to an antenna; and
then stopping the introduction of the CO-containing gas into the vacuum chamber to thereby generate a cleaning plasma with the use of a cleaning gas containing the O element or an H element.

6. The plasma etching method according to claim 1, further comprising:
switching the gas from the etching gas for etching the object to be processed to a rare gas in a state of having kept the plasma state, after having etched the object to be processed; and
then switching the gas from the rare gas to the cleaning gas for removing the carbon deposit in the state of having kept the plasma state.

7. The plasma etching method according to claim 6, further comprising:
switching the gas from the etching gas to the rare gas and then further to the cleaning gas by: starting the introduction of the rare gas into the vacuum chamber while supplying the etching gas into the vacuum chamber in a state of applying a source electric power to an antenna after having etched the material to be etched;
then stopping the introduction of the etching gas;
starting the introduction of the cleaning gas while supplying the rare gas into the vacuum chamber in a state of applying the source electric power to the antenna;
then stopping the introduction of the etching gas;
stopping the application of a wafer bias electric power to the wafer simultaneously with the introduction of the cleaning gas; and
thus switching the gas while keeping the plasma state.

8. The plasma etching method according to claim 2, further comprising:
applying a source electric power to a combustible CO-containing gas containing elements of C and O, which has been introduced into the vacuum chamber, to convert the CO-containing gas into a plasma state;
etching the magnetic film formed on the wafer to be etched with the generated CO-containing plasma;
processing the magnetic film formed on the wafer to be etched with the plasma of the gas that contains CO and contains the combustible gas;
introducing a rare gas and N₂ gas into the vacuum chamber in a state of applying the source electric power;
then stopping the introduction of the gas that contains CO and contains the combustible gas;
further introducing a cleaning gas containing a combustion-supporting gas;
then stopping the introduction of the rare gas and N₂ gas; and
thereby generating cleaning plasma using the cleaning gas containing the combustion-supporting gas.
